(19) United States
(12) Patent Application Publication
(10) Pub. No.: US 2006/0279196 A1
(43) Pub. Date: Dec. 14, 2006

(54) White LED

(76) Inventor: Wei-Jen Hsu, Taipei City (TW)

Correspondence Address: BIRCH STEWART KOLASCH & BIRCH, PO BOX 747, FALLS CHURCH, VA, 22040-0747, US

(21) Appl. No.: 11/142,402

(22) Filed: Jun. 2, 2005

(51) Int. Cl. H01J 1/62; H01J 63/04

(52) U.S. Cl. 313/486

(57) ABSTRACT

A white LED comprising at least an excitation light source and a fluorescent powder, the excitation light source issues light with wavelength between 285 nm to 490 nm, the fluorescent powder is installed around the excitation light source to receive the light from the excitation light source; the materials of the fluorescent powders is one of the (Ca,Sr,Ba,)₈Mg(SiO₄)₄Cl₂:Eu²⁺, Dy³⁺, Mn³⁺ for better luminant efficiency and better excitation effect.

### BACKGROUND OF THE INVENTION

I. Field of the Invention

This invention relates generally to a white LED (Light Emitting Diode) and, more specifically, to a white LED that excites three to four wavelength high excitation effect by blue light. The fluorescent powders of the present invention are new silicate, totally different from YAG and TAG materials, and do not contain chemical elements such as Y, Tb, Al and Ce, the light source is not Ce; the silicate of the fluorescent powders takes Eu as light source that is different from the patterns of Nichia's YAG and Osram's TAG; the present invention solves Blue-chip packaging issues, bad color performance issues, offers brighter effect, also improves UV-chip packaging brightness issues and brings UV-chip into real application step.

II. Description of the Prior Art

Heretofore, it is known that LED is a semiconductor component, the major luminous elements are most of III-V Chemical elements, such as GaP, GaAs and GaN compound semiconductors; the principle of light emitting is to transfer electrical power into light, that is to have electrical current onto these compound semiconductors, by the combination of electronics and electronic holes, the left over energy is released in light format as light emitting effect. The light emitting is not by heating or electricity discharge but cold light emitting, the lifetime is more than 100 thousands hours and no idling time is needed. The LED has very short response time (about 10⁻⁹ sec.), small physical size, power saving, low pollution (no Mercury), high reliability and easy for mass production advantages, the application area is very wide; among all the LED's, white LED is the most noticeable. The ruminant efficiency of LED gets higher and higher, white LED in some application field, such as light source of Scanners, back light source of LCD's or lighting equipment, LED's might replace traditional fluorescent lamps and light bulbs.

The known white LED is to have blue LED collocate with inorganic yellow fluorescent powders (or organic yellow fluorescent powders) to generate white light. The wavelength of the blue light by the blue LED is between 440 nm to 490 nm, when the blue beam shines on the inorganic yellow fluorescent powders, the inorganic yellow fluorescent powders reflect yellow fluorescent light, after combination with the original blue light, white light is generated. Such white light LED is easier than the first type in manufacturing, the manufacturing cost is also lower, and most of the white LED's in the market are this type. However the efficiency of this type of white light LED is lower, the light is two wavelengths type (blue and yellow light), the color temperature and saturation is not so good as other three-wavelength type white type LED's.

Recently, white light LED's are limited by the patterns of Nichia over blue LED and Y₃Al₅O₁₂:Ce³⁺ (known and called YAG) type of LED (WO 98/05078, WO 98/12757) and Osram's fluorescent powder Tb₃Al₅O₁₂:Ce³⁺ (known and called TAG) patterns; under the limitation of these patterns, now whole world is fighting for these patterns and finding the replacement fluorescent powders of YAG and TAG to break the patterns of Nichia, the white light LED by the combination of blue light LED and YAG, TAG in the color temperature and saturation is not so good as other three-wavelength type white LED's, and the recent demand in high-power LED's needs more in color temperature and saturation and high stability, high efficiency demands; the present invention is different from YAG and TAG materials, is new silicon acid fluorescent powder, and takes Eu as the fluorescent center.

### SUMMARY OF THE INVENTION

It is therefore a primary object of the invention to provide a white LED that is excited through ultraviolet and blue light and generated 3 to 4 wavelength to offer higher luminant efficiency and brighter light. The fluorescent powders of the present invention are different from YAG of Nichia and TAG of Osram, these fluorescent powders do not contain Y, Tb, Al and Ce, and do not take Ce as light issuing center; The Silicate of fluorescent powders of the present invention take Ca, Sr, Ba, Mg, Cl and SiO₄ as basic materials and have Eu as light issuing center. The advantages of the new fluorescent powders: the water-resistant of Silicate of fluorescent powders is better than that of Aluminate, better pervious performance and luminant efficiency, Eu is luminance source, not so easy to decay and more stable than Ce. New Silicate fluorescent powders have Ca, Sr and Ba as basic materials that has lower specific gravity (the specific gravity of Silicate of the fluorescent powders=3.358, YAG & TAG=4.33), the fluorescent powders will not sink during LED packaging, the packaging result is better.

The excitation wavelength of the fluorescent powders is between 250 nm to 485 nm that is suitable for UV and Blue Chip dies that is different from other fluorescent powders only absorb small portion of wavelength; the fluorescent powders of the present invention can take wider range of excitation wavelength that offers more stable emission wavelength to transfer energy from LED dies, that gives better luminant efficiency especially suitable for LED with wavelength between 250 nm to 485 nm, after packaging, the present invention give better color stability and brightness.

In order to achieve the objective set forth, a white LED in accordance with the present invention comprises at least a carrier with a protruding part on a plane or a protruding part on a concave to lift luminant efficiency for better brighter efficiency; the carrier has a protruding part on a plane or a protruding part on a concave, the excitation light source is installed inside the concave and connects to the carrier electrically, the excitation light source issues light beam with wavelength between 250 nm to 490 nm. The packaging installed on top of the carrier to cover the excitation light source and fix said excitation light source firmly on the carrier.

The fluorescent powder is installed around the excitation light source to receive light beam issued by said excitation light source, the new fluorescent powder one or more of (Ca, Sr, Ba,)₈Mg(SiO₄)₄Cl₂:Eu²⁺, Dy³⁺, Mn³⁺.

Several wires connect the excitation light source and the carrier of the white LED electrically. The carrier includes either one of lead frame or circuit board. The excitation light source includes either one of LED die or LASER LED die.

The light beam of the white LED has wavelength between 440 nm to 490 nm, the fluorescent powder contains one or more of (Me_{1-x-y}EuₓRe_{y})₈Mg_{z}(SiO₄)ₘ,Clₙ:, and (Me₁₋ₓEuₓ)ReS, and Re contains more than one member of Praseodymium, Rubidium, Samarium, Dysprosium, Holmium, Yttrium, Erbium, Europium, Thulium, Ytterbium, Lutetium, Gadolinium, Magnesium and Manganese groups.

The materials of the fluorescent powders can be adjusted according to the wavelength of the excitation light source, for example, when the light beam has wavelength between 250 nm to 440 nm, then the fluorescent powder contains one or more of (Me_{1-x-y}EuₓRe_{y})₈Mg_{z}(SiO₄)ₘ,Clₙ:, (Me₁₋ₓEuₓ)ReS, Gd²⁺, and Ca_{1-x-y},Srₓ,Ba_{y})₅(PO₄)₃Cl:Eu²⁺.

The fluorescent powders materials described above contain (Me_{1-x-y}EuₓRe_{y})₈Mg_{z}(SiO₄)ₘ,Clₙ:, 0<x≦0.8, and 0≦y≦2.0, 0≦Z≦1.01, 1.0≦m≦6.0, 0.1≦n≦3.0. Me contains more than one more member of Calcium, Strontium and Barium groups, and Re contains more than one member of Praseodymium, Rubidium, Samarium, Dysprosium, Holmium, Yttrium, Erbium, Europium, Thulium, Ytterbium, Lutetium, Gadolinium, Magnesium and Manganese groups.

By adjusting the ratio of Ca, Sr, Mg, SiO₄, Eu, Dy and Mn Silicate, the fluorescent powders can be made to issue green, magenta light; the red fluorescent powders contains (Sr_{0.78}Ca_{0.17})S:Eu_{0.1}Sm_{0.015} and applies Na₂S s Na₂S process, with addition of Sm for better luminant efficiency and heat-resistance. The blue fluorescent powder contains Sr_{4.7}(PO₄)₂Cl:Eu_{0.15}Gd_{0.15} with addition of Gd to increase the luminant efficiency up to two times.

Based on above description, the white LED of the present invention is to apply the LED dies (or LASER diodes) having wavelength between 250 nm to 490 nm as excitation light sources to excite the fluorescent powders in different materials to generate different colors, such as yellow, red, green and blue fluorescent light and mix with the original excitation light source, finally form white light. The white LED of the present invention is the three-wavelength or four-wavelength type white LED and die for better luminant efficiency and better excitation effect.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is an application view of the present invention;

FIG. 2a˜c is another application view of the present invention;

FIG. 3a˜d is structure view of a further embodiment of the present invention;

FIG. 4 is the excitation spectrogram and emission spectrogram of Ca_{7.8}Mg(SiO₄)₄Cl₂:Eu_{0.12}Dy_{0.08}, the wavelength is 502.8 nm;

FIG. 5 is the XRD spectrogram of the powder with Ca_{7.8}Mg(SiO₄)₄Cl₂:Eu_{0.12}Dy_{0.08}, of green fluorescent material with addition of Europium and Dysprosium.

FIG. 6 is the excitation spectrogram and emission spectrogram of Ca_{7.6}Mg(SiO₄)₄Cl₂:Eu_{0.32}Dy_{0.08}, with addition of Eu, the wavelength becomes 511.8 nm;

FIG. 7 is the excitation spectrogram and emission spectrogram of (Sr_{7.48}Ca_{0.2})Mg(SiO₄)₄Cl₂:Eu_{0.12}Mn_{0.2}, the wavelength is 563 nm;

FIG. 8 is the XRD spectrogram of (Sr_{7.48}Ca_{0.2)}Mg(SiO₄)₄Cl₂:Eu_{0.12}Mn_{0.2} of magenta fluorescent material with addition of Europium and Manganese;

FIG. 9 is the excitation spectrogram and emission spectrogram of (Sr_{7.28}Ca_{0.2})Mg(SiO₄)₄Cl₂:Eu_{0.32}Mn_{0.2}, with addition of Eu, the wavelength becomes 612.2 nm;

FIG. 10 is the excitation spectrogram and emission spectrogram (Sr_{0.78}Ca_{0.17})S:Eu_{0.1}Sm_{0.015}, the wavelength becomes 616.2 nm;

FIG. 11 is the XRD spectrogram (Sr_{0.78}Ca_{0.17})S:Eu_{0.1}Sm_{0.015} of red fluorescent material with addition of Europium and Samarium;

FIG. 12 is the excitation spectrogram and emission spectrogram of (Sr_{0.35}Ca_{0.6})S:Eu_{0.1}Sm_{0.015}, with addition of Ca, the wavelength becomes 641.8 nm;

FIG. 13 is the excitation spectrogram and emission spectrogram of Sr_{4.7}(PO₄)₂Cl:Eu_{0.15}Gd_{0.15}, with addition of Gd, the strength increases two times;

FIG. 14 is the XRD spectrogram Sr_{4.7}(PO₄)₂Cl:Eu_{0.15}Gd_{0.15} of blue fluorescent material with addition of Europium and Gadolinium;

FIG. 15 is the excitation spectrogram and emission spectrogram of Sr_{4.85}(PO₄)₂Cl:Eu_{0.15};

FIG. 16 is the combinational three-wavelength spectrogram of 20% green fluorescent powders Ca_{7.8}Mg(SiO₄)₄Cl₂:Eu_{0.12}Dy_{0.08} with 80% Magenta fluorescent powders (Sr_{7.48}Ca_{0.2})Mg(SiO₄)₄Cl₂:Eu_{0.12}Mn_{0.2}, the wavelength of the LED die is 455 nm blue excitation light;

FIG. 17 is the spectrogram of 100% Ca_{7.8}Mg(SiO₄)₄Cl₂:Eu_{0.12}Dy_{0.08} green fluorescent powder, the wavelength of the excitation light of the LED die is blue 455 nm;

FIG. 18 is the spectrogram of the proper combination of magenta fluorescent powder, green fluorescent powder, red fluorescent powder (Sr_{0.78}Ca_{0.17})S:Eu_{0.1}Sm_{0.015} and blue fluorescent powder Sr_{4.7}(PO₄)₂Cl:Eu_{0.15}Gd_{0.15}, and the excitation light source purple light with 385 nm wavelength.

### DESCRIPTION OF THE PREFERRED EMBODIMENT

Following examples are application of the fluorescent powders of the present invention:

### APPLICATION EXAMPLE 1 (GREEN FLUORESCENT POWDER)

1. Take 5.0 g CaCO₃, 1.83 g SiO₂, 0.5860 g Eu₂O₃, 0.4141 g Dy₂O₃ and 1.1185 g MgO, grind and mix them evenly, then add proper HCl and form Ca_{7.8}Mg(SiO₄)₄Cl₂:Eu_{0.12}Dy_{0.08}.

2. Place the mixed material into a crucible and bake in open air at 5° C./min rising rate up to 1200° C. for calcinations. 6 hours later lower the temperature at 5° C./min rate cool down to room temperature.

3. Grind the calcinations powder and place them into a crucible sintering in open air at 1200° C. for 5 hours, the temperature rising rate is still 5° C. /min.

4. Grind the sintering powder and place them in H₂/N₂ (15%/85%) gas at 1000° C. for reduction for 6 hours to change Eu³⁺ ions into Eu²⁺ for brighter effect, however this is not a necessary process.

Following are the examples of this process:

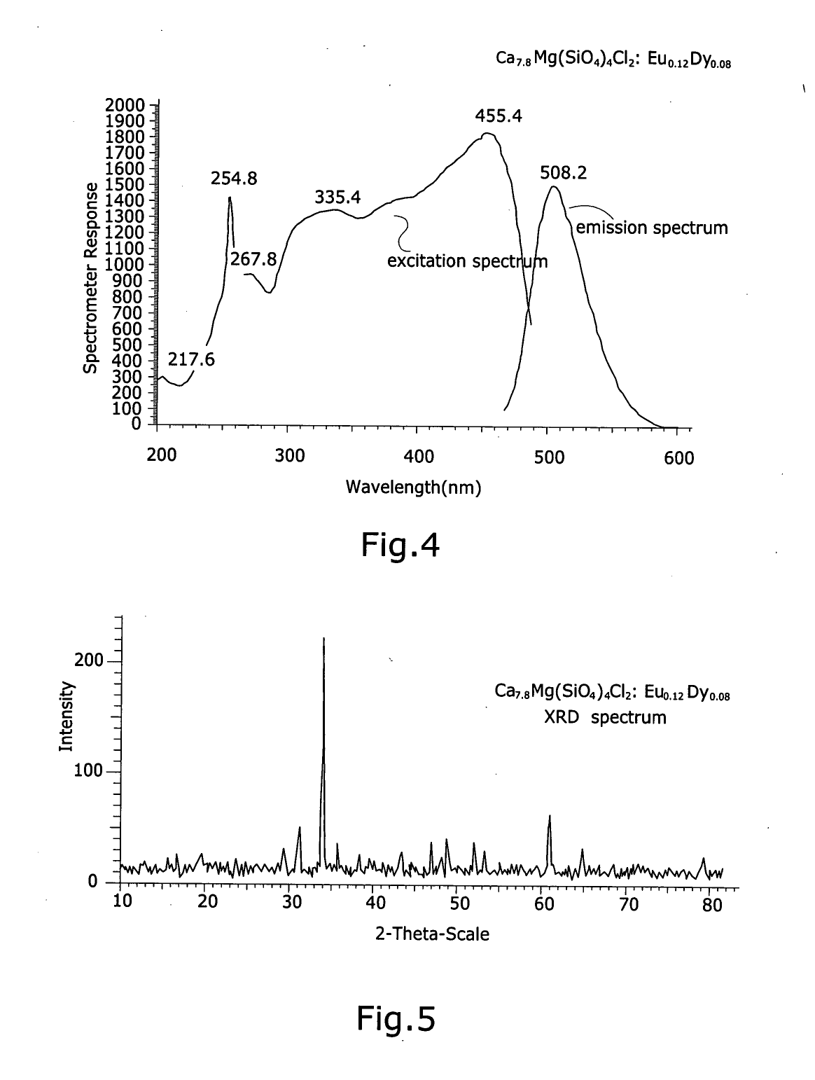

FIG. 4: The excitation spectrogram and emission spectrogram of Ca_{7.8}Mg(SiO₄)₄Cl₂:Eu_{0.12}Dy_{0.08}.

FIG. 5: The XRD spectrogram of the powder with Ca_{7.8}Mg(SiO₄)₄Cl₂:Eu_{0.12}Dy_{0.08}.

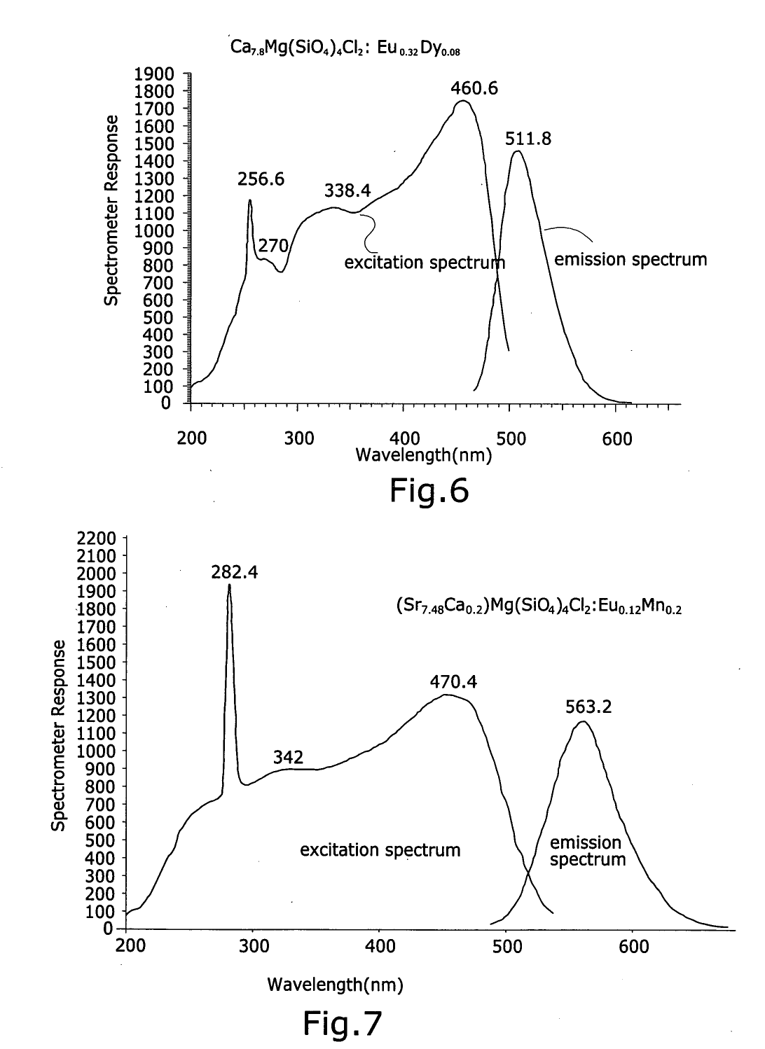

FIG. 6: The excitation spectrogram and emission spectrogram of Ca_{7.6}Mg(SiO₄)₄Cl₂:Eu_{0.32}Dy_{0.08}.

### APPLICATION EXAMPLE 2 (MAGENTA FLUORESCENT POWDER)

1. Take 5.0 g SrCO₃, 0.9970 g CaCO₃, 3.29 g SiO₂, 1.0515 g Eu₂O₃, 1.145 g Mn₂O₃ and 2.007 g MgO, then grind and mix them evenly; add proper amount of HCl and turn them into (Sr_{7.48}Ca_{0.2})Mg(SiO₄)₄Cl₂:Eu_{0.12}Mn_{0.2}.

2. Place the mixed material into a crucible and bake in Helium gas at 5° C./min rising rate up to 1250° C. for calcinations. 6 hours later lower the temperature at 5° C./min rate cool down to room temperature.

3. Grind the calcinations powder and place them into a crucible sintering in open air at 1250° C. for 5 hours, the temperature rising rate is still 5° C./min.

4. Grind the sintering powder and place them in H₂/N₂ (15%/85%) gas at 1000° C. for reduction for 6 hours to change Eu³⁺ ions into Eu²⁺ for brighter effect, however this is not a necessary process.

Following are the examples of this process:

FIG. 7: The excitation spectrogram and emission spectrogram of (Sr_{7.48}Ca_{0.2})Mg(SiO₄)₄Cl₂:Eu_{0.12}Mn_{0.2}.

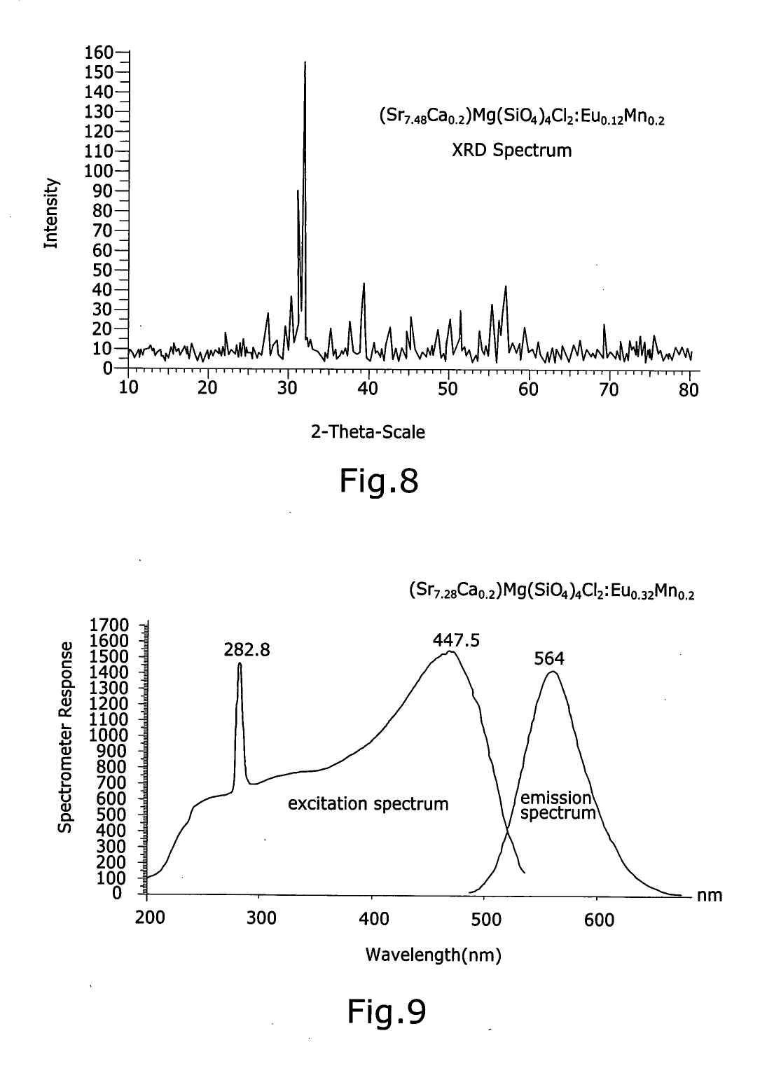

FIG. 8: The XRD spectrogram of (Sr_{7.48}Ca_{0.2)}Mg(SiO₄)₄Cl₂:Eu_{0.12}Mn_{0.2}.

FIG. 9: The excitation spectrogram and emission spectrogram of (Sr_{7.28}Ca_{0.2})Mg(SiO₄)₄Cl₂:Eu_{0.32}Mn_{0.2}.

### APPLICATION EXAMPLE 3 (RED FLUORESCENT POWDER)

1. Take 0.8059 g of CaCO₃, 5.0 g SrCO₃, 3.6945 g Na₂S, 1.6668 g Eu₂O₃ and 0.3812 g Sm₂O₃, grind and mix all together evenly, the compound becomes (Sr_{0.78}Ca_{0.17})S:Eu_{0.1}Sm_{0.015}.

2. Place the mixed material into a crucible and bake to 1100° C. for calcinations and reduction in H₂/N₂ (15%/85%) gas. 6 hours later lower the temperature at 5° C./min rate cool down to room temperature.

3. Grind the sintering powder and place them in H₂/N₂ (15%/85%) gas at 1100° C. for reduction for 6 hours to change Eu³⁺ ions into Eu²⁺ for brighter effect, however this is not a necessary process.

4. The production of red fluorescent powder applies Na₂S process, with addition of Sm for better luminant efficiency and heat-resistance.

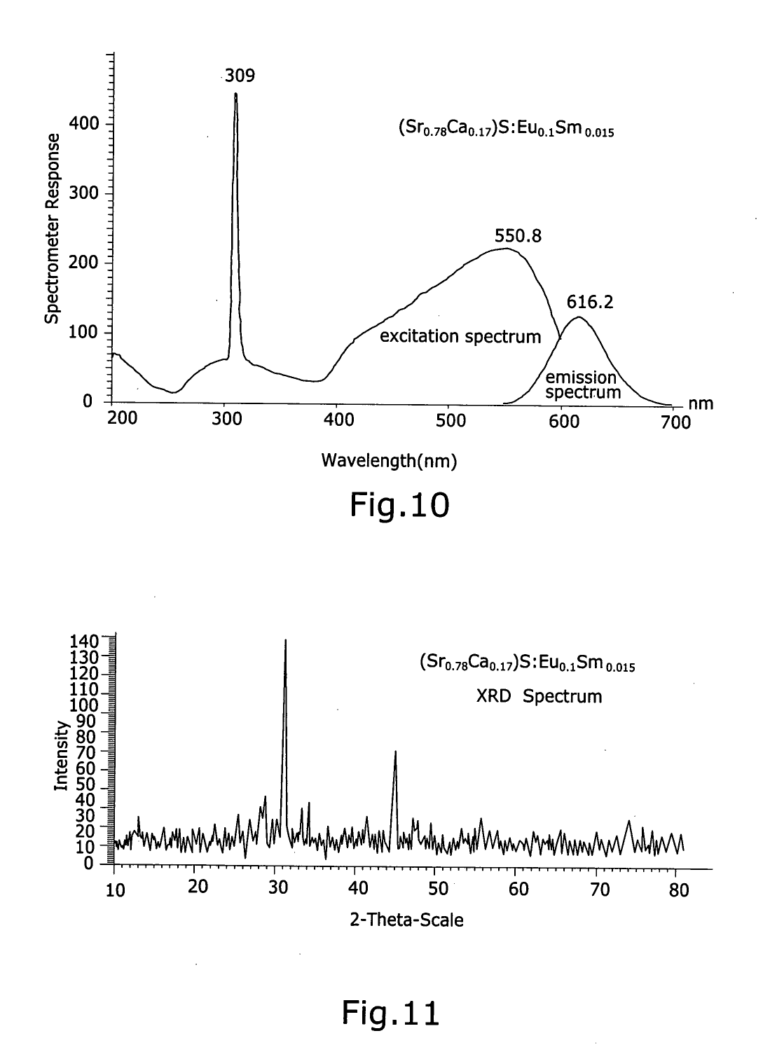

FIG. 10: The excitation spectrogram and emission spectrogram (Sr_{0.78}Ca_{0.17})S:Eu_{0.1}Sm_{0.015}.

FIG. 11: The XRD spectrogram (Sr_{0.78}Ca_{0.17})S:Eu_{0.1}Sm_{0.015} of red fluorescent material with addition of Europium and Samarium.

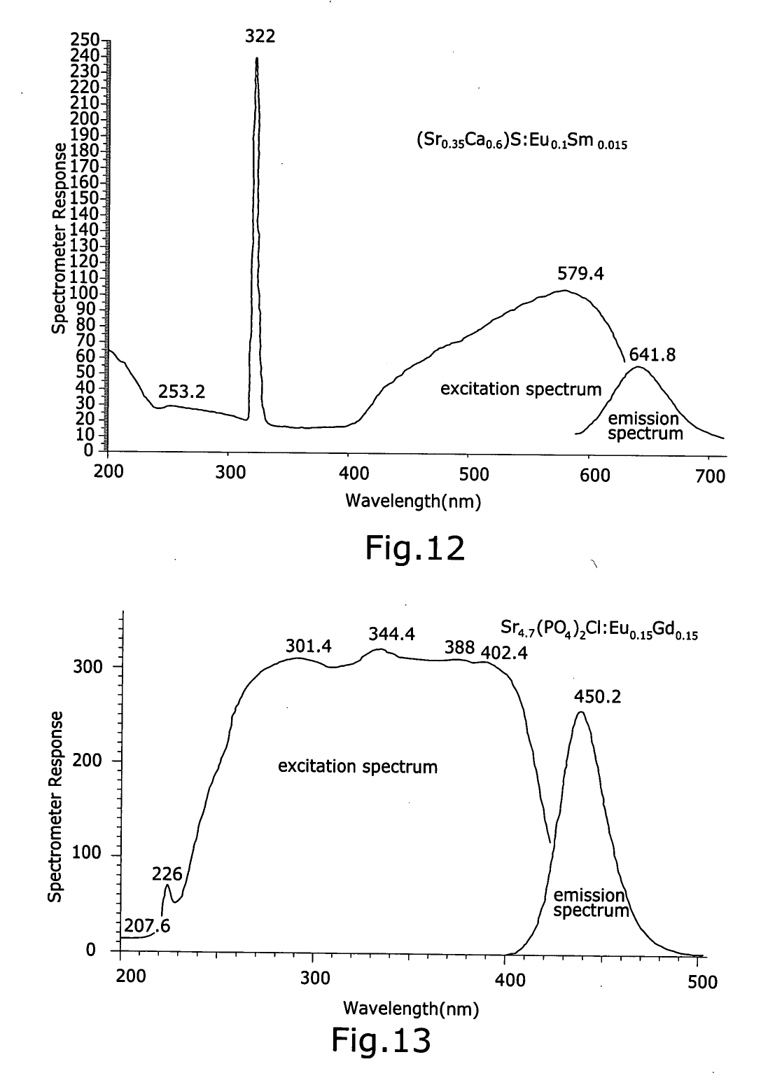

FIG. 12: The excitation spectrogram and emission spectrogram of (Sr_{0.35}Ca_{0.6})S:Eu_{0.1}Sm_{0.015}.

### APPLICATION EXAMPLE 4 (BLUE FLUORESCENT POWDER)

1. Take 5 g of SrCO₃, 0.3575 g Eu₂O₃ and 0.3683 g Gd₂O₃, CaCO₃, grind and mix all together evenly with HCl and 2.31 g H3PO₄, the compound becomes Sr_{4.7}(PO₄)₂Cl:Eu_{0.15}Gd_{0.15}.

2. Place the mixed material into a crucible and bake in Helium gas at 5° C./min rising rate up to 1250° C. for calcinations. 6 hours later lower the temperature at 5° C./min rate cool down to room temperature.

3. Grind the calcinations powder and place them into a crucible sintering in open air at 1250° C. for 5 hours, the temperature rising rate is still 5° C./min.

4. Grind the sintering powder and place them in H₂/N₂ (15%/85%) gas at 1000° C. for reduction for 6 hours to change Eu³⁺ ions into Eu²⁺ for brighter effect, however this is not a necessary process.

5. The production of Blue fluorescent powder adds Gd for better luminant efficiency.

FIG. 13 is the excitation spectrogram and emission spectrogram of Sr_{4.7}(PO₄)₂Cl:Eu_{0.15}Gd_{0.15}.

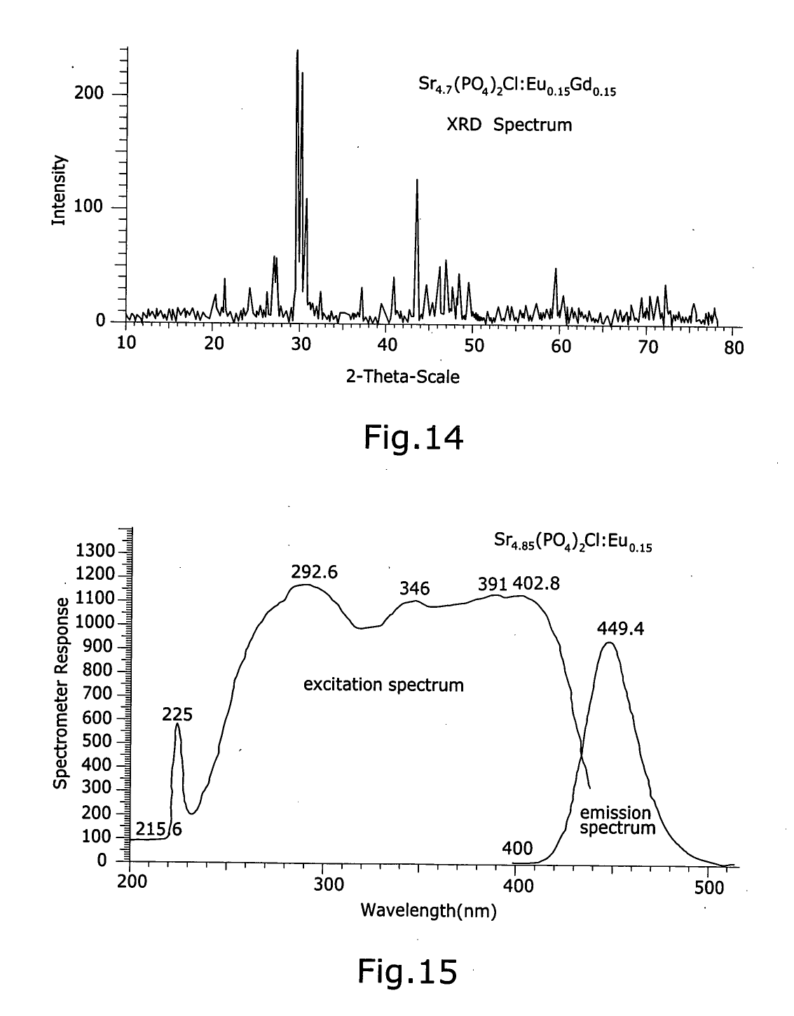

FIG. 14: The XRD spectrogram Sr_{4.7}(PO₄)₂Cl:Eu_{0.15}Gd_{0.15} of blue fluorescent material with addition of Europium and Gadolinium.

FIG. 15: The excitation spectrogram and emission spectrogram of Sr_{4.85}(PO₄)₂Cl:Eu_{0.15}.

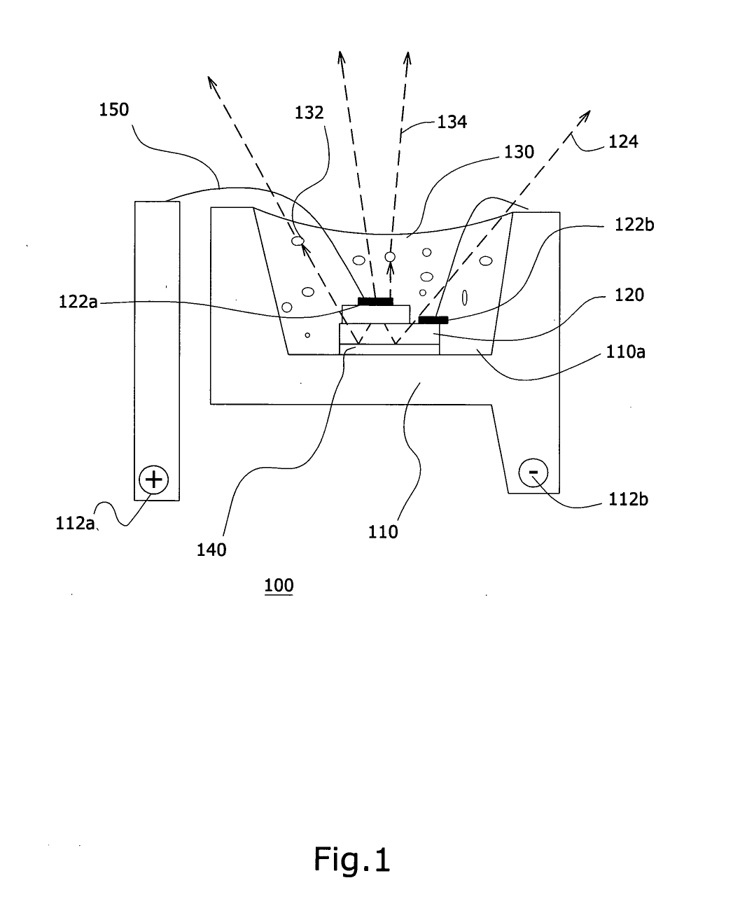

Referring to FIG. 1, a perspective view of the white LED of the present invention. The white LED 100 comprises of a lead frame 110, an LED die 120 and a packaging 130, the lead frame 110 further comprises of a first contact 112a, a second contact 112b and a concave 110a, the LED die 120 is fixed onto the concave 110a by a glue 140. The LED die 120 contains a positive electrode 122a and a negative electrode 122b connecting to the first contact 112a and the second contact 112b of the lead frame 110 electrically through a soldering wire 150 respectively, the packaging 130 covers the LED die 120 on top to fix the LED die 120 firmly inside the concave 110a.

Referring to FIG. 1 again, the LED die 120 can issue a light beam 124, the packaging 130 contains fluorescent powders 132, partial of the light beam 124 can pass through the packaging 130, the rest of light beam 124 shines to the fluorescent powders 132. After the excitation of light beam 124, the fluorescent materials in the fluorescent powders 132 generates electron migration and generates a fluorescent light 134; by the combination of the light beam 124 and the fluorescent light 134, the white LED 100 can issue white light.

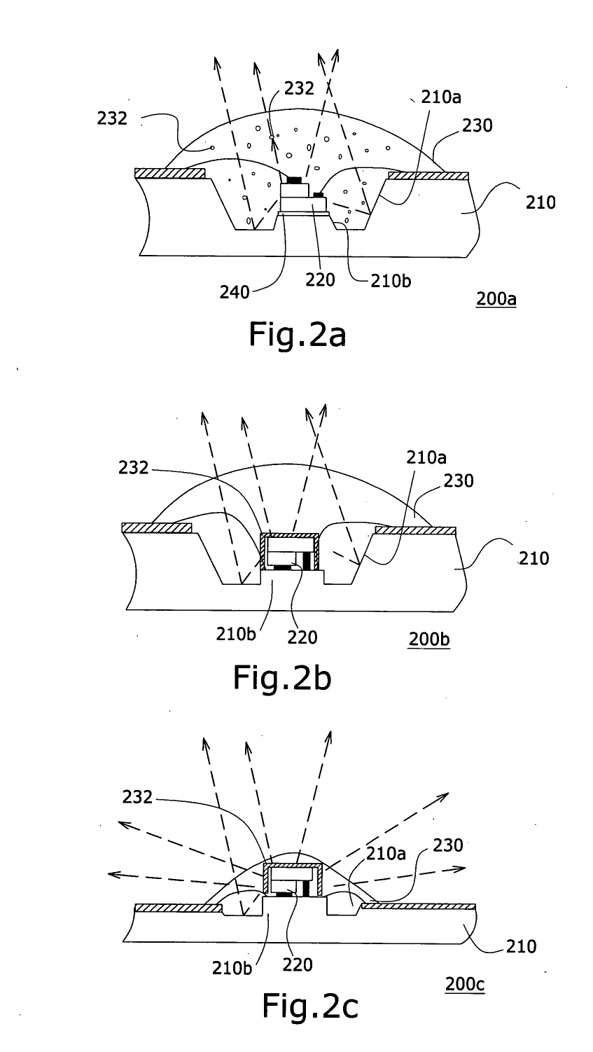

Besides the lead frame 110 described above, the white LED 100 of the present invention can have a circuit board to replace the lead frame 110; referring to FIG. 2a, another perspective view of the white LED of the present invention. The white LED 200a comprises of a circuit board 210, an LED die 220 and a packaging 230; the LED die 220 is fixed onto a protruding part on a plane or a protruding part on a concave 210b of a concave 210a by the glue 240, the LED die 220 connects to the circuit board 210 through wire-bonding. The packaging 230 contains fluorescent powders 232, the packaging 230 covers the top of the LED die 220. The related components are identical to the application example in FIG. 1, please refer to description of FIG. 1. A perspective view of another white LED. The packaging of the LED can cover the white LED 200b and 200c.

The two electrodes of two above application examples are on the top of the LED die of the LED, however, in real application, the protruding part on a plane or the protruding part on a concave 210b of the concave 210a can lift the luminant efficiency for better brighter efficiency; two electrodes can also be on top or bottom of the LED die; the different locations of the electrodes, the connection between the LED die and the lead frame (circuit board) are also different.

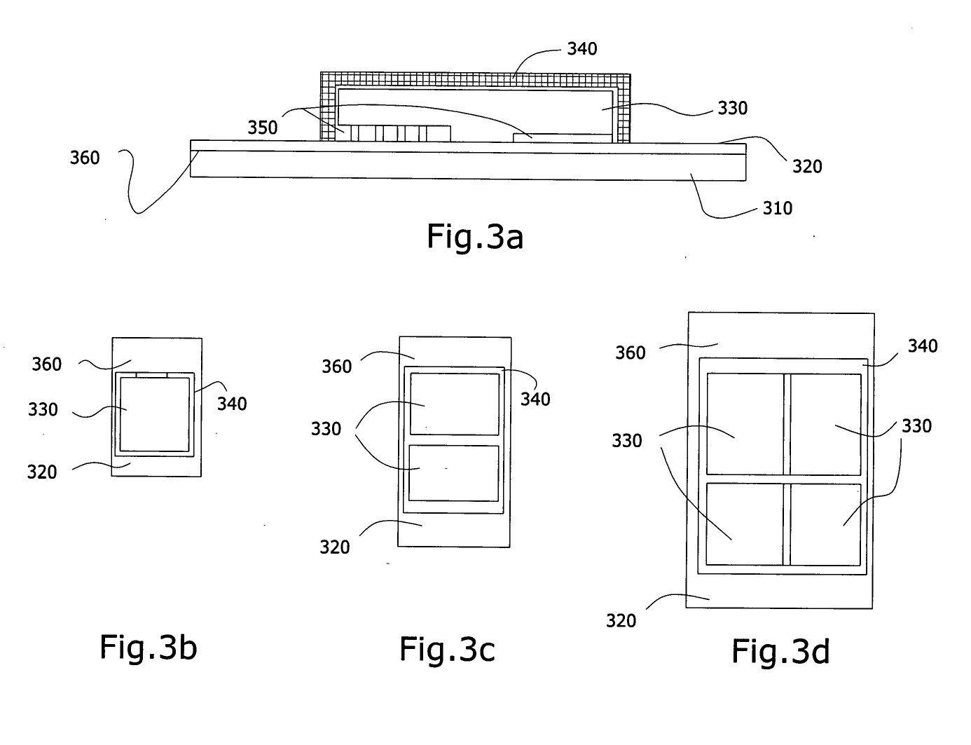

Referring to FIG. 3a to 3d, the cross section view and top view of the white LED die of the present invention. A circuit board 310, an LED die layer 330 and a fluorescent powder layer 340, the LED die layer 330 connects to the positive electrode 320 and the negative electrode 360 of the circuit board 310 electrically with a contacting layer 350; the thickness of the fluorescent powder layer 340 is between 0.5 mm to 3.0 mm to lift the luminant efficiency for better brighter efficiency.

Based on the characteristic of the present invention, the wavelength of the light beam issued by above LED dies is between 250 nm to 490 nm, the fluorescent powders include green fluorescent powder, magenta fluorescent powder, red fluorescent powder and blue fluorescent powder. The materials of the green and magenta fluorescent powder can be one or more than two of (Me_{1-x-y}EuₓRe_{y})₈Mg_{z} (SiO₄)ₘ, Clₙ:; the materials of the red fluorescent powder can be one of the (Me_{1-x-y}EuₓRe_{y})S: group, blue fluorescent powder can be one of the (Ca_{1-x-y},Srₓ,Ba_{y})₅(PO₄)₃Cl:Eu²⁺,Gd²⁺ group; 0<x≦0.8, and 0≦y≦2.0, 0≦Z≦1.0, 1.0≦m≦6.0, 0.1≦n≦3.0. Me can be one of Calcium, Strontium or Barium, Re can be one or two members of Praseodymium, Rubidium, Samarium, Dysprosium, Holmium, Yttrium, Erbium, Europium, Thulium, Ytterbium, Lutetium, Gadolinium, Magnesium or Manganese groups.

The light frequencies of the different LED die and the accompanying fluorescent powders issue different light beam frequencies, following are examples:

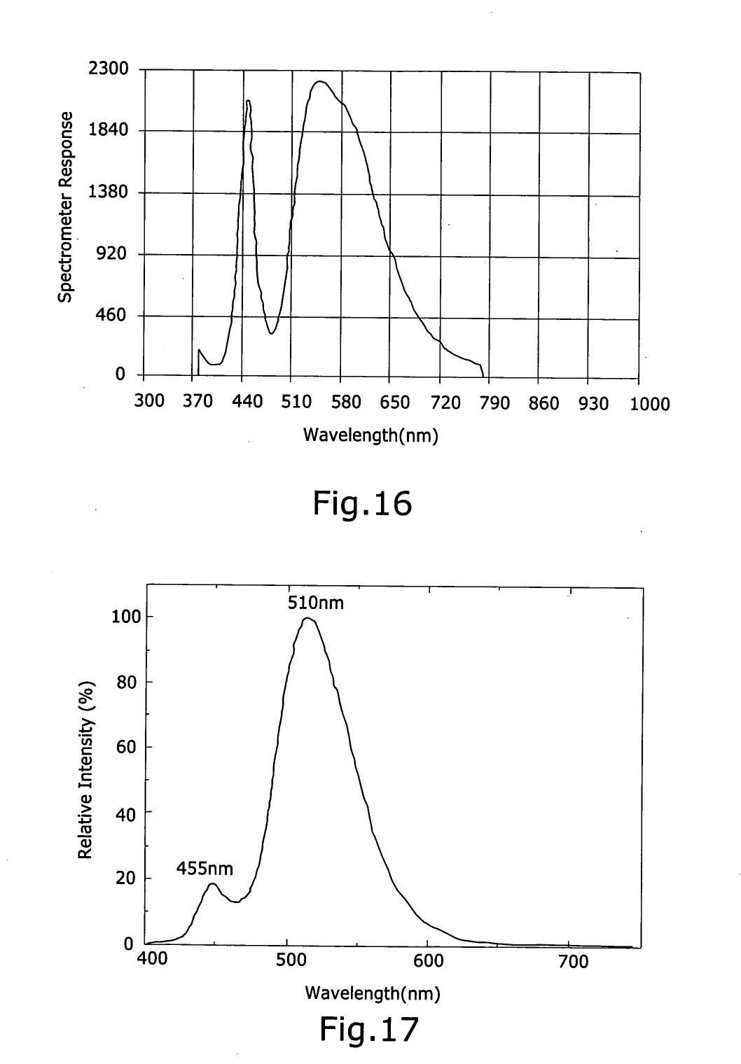

Application Example 5 (light wavelength between 440 nm to 490 nm): when the LED die is a blue LED with light wavelength between 440 nm to 490 nm, the fluorescent powders include green and magenta fluorescent powders with lower excitation energy. Referring to FIG. 4, the emission spectrogram of a white LED the first example, the combination ratio of the fluorescent powders is 20% green fluorescent powders Ca_{7.8}Mg(SiO₄)₄Cl₂:Eu_{0.12}Dy_{0.08} with 80% Magenta fluorescent powders (Sr_{7.48}Ca_{0.2)}Mg(SiO₄)₄Cl₂:Eu_{0.12}Mn_{0.2}, the wavelength of the LED die is 455 nm blue ligh after excitation the green fluorescent powder issue green light with wavelength between 510 nm to 525 nm, the magenta fluorescent powder issues magenta light with wavelength between 560 nm to 590 nm. The combination of blue excitation light, green and magenta light forms bright white light, the white LED of the present invention is three-wavelength type white LED, as shown in FIG. 16.

Application Example 6, based the description of example 5 above, to change the fluorescent powders type and combination ratio, the output results of the white LED are different. If the fluorescent powder is changed to 100% Ca_{7.8}Mg(SiO₄)₄Cl₂:Eu_{0.12}Dy_{0.08} green fluorescent powder, if the wavelength of the LED die is blue 455 nm, after excitation, the green fluorescent powder issues green light that forms a high bright green LED. The blue LED with fluorescent powders can be packed into green LED that has high bright, the best LED product in the world, as shown in FIG. 17.

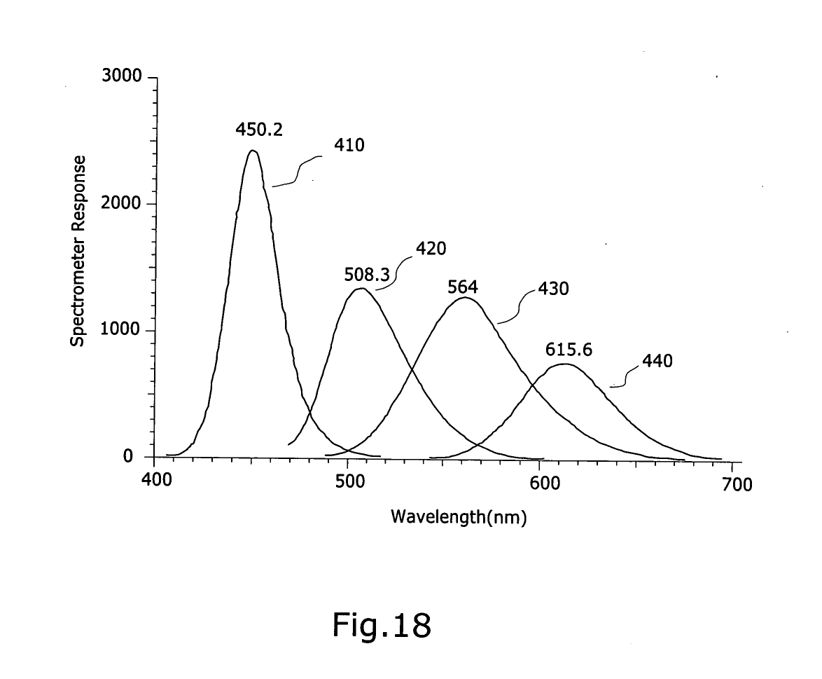

Application Example 7 (excitation light wavelength between 250 nm to 440 nm): referring to FIG. 18, the emission spectrogram of white LED of example 5 described above; take proper ratio of the fluorescent powders that includes magenta fluorescent powder, green fluorescent powder, red fluorescent powder (Sr_{0.78}Ca_{0.17})S:Eu_{0.1}Sm_{0.015} and blue fluorescent powder Sr_{4.7}(PO₄)₂Cl:Eu_{0.15}Gd_{0.15}, and then take a purple excitation light source with 385 nm wavelength. After excitation, green fluorescent powder issues green light beam 420 with 502.8 nm wavelength, blue fluorescent powder issue blue light beam 410 with 450.2 nm wavelength, red fluorescent powder issues red light beam 440 with 615.6 nm strengthened wavelength, magenta fluorescent powder issues magenta light beam 430 with 564 nm wavelength, together they form a better four-wavelength white light, as shown in FIG. 18.

By the examples described above, the white LED of the present invention applies higher excitation light, such as purple excitation light with wavelength between 365 nm to 395 nm, or ultraviolet light with even lower wavelength (smaller than 365 nm); the fluorescent powders besides the known popular red fluorescent powder and magenta fluorescent powder, they also include green and blue fluorescent powders that need higher excitation energy. The shorter wavelength of the excitation light of the LED dies of the present invention, the higher the energy, the more kinds of fluorescent powders can be applied, the better excitation effect of the fluorescent powders.

Based on above description, the characteristic of the present invention is to apply the excitation light sources having wavelength between 250 nm to 490 nm to excite the fluorescent powders in different colors, by the different wavelength (frequency) of the excitation sources, the material of the excited fluorescent powders are also different. Compare with the known two-wavelength white LED, the three-wavelength and four-wavelength white LED's have better luminant efficiency and better excitation effect. Compare to multiple LED's for white light LED, the white LED's of the present invention have lower manufacturing cost and faster manufacturing process.

Besides the white LED's of the present invention described above, the excitation sources also include other excitation sources such as LASER diodes. The ratio and materials of the fluorescent powders applied in the present invention can be modified according to the needs of the output light (colors or brightness) and the wavelength of the excitation sources; by the different deployment of the fluorescent powders, the white LED of the present invention can output specific brightness or colors, a full spectrum of color LED's can be developed.

While a preferred embodiment of the invention has been shown and described in detail, it will be readily understood and appreciated that numerous omissions, changes and additions may be made without departing from the spirit and scope of the invention.

What is claimed is:

1. A white LED comprising:
an excitation light source issues light beam with wavelength between 250 nm to 490 nm; and
a fluorescent powder placed around said light source to receive said light beam issued, said fluorescent powder is mixed with one or more of (Me_{1-x-y}EuₓRe_{y})₈Mg_{z}(SiO₄)ₘ,Clₙ, (Me₁₋ₓEuₓ)ReS and (Ca_{1-x-y},Srₓ,Ba_{y})₅(PO₄)₃Cl:Eu²⁺,Gd^{2+.}

2. The white LED recited in claim 1, wherein said light beam has wavelength between 440 nm to 490 nm, said fluorescent powder is mixed with one or more of (Me_{1-x-y}EuₓRe_{y})₈Mg_{z}(SiO₄)ₘ,Clₙ: [symbol] (Me₁₋ₓEuₓ)ReS.

3. The white LED recited in claim 1, wherein said light beam has wavelength between 250 nm to 440 nm, said fluorescent powder is mixed with one or more of (Me_{1-x-y}EuₓRe_{y})₈Mg_{z}(SiO₄)ₘ,Clₙ:, (Me₁₋ₓEuₓ)Re Sand (Ca_{1-x-y},Srₓ,Ba_{y})₅(PO₄)₃Cl:Eu²⁺, Gd^{2+.}

4. The white LED recited in claim 1, wherein 0<x≦0.8, and 0≦y≦2.0, 0≦Z≦1.0, 1.0≦m≦6.0, 0.1≦n≦3.0.

5. The white LED recited in claim 1, wherein said Me is one or more member of Calcium, strontium, barium groups.

6. The white LED recited in claim 1, wherein the Re is one or two of Praseodymium, Rubidium, Samarium, Dysprosium, Holmium, Yttrium, Erbium, Europium, Thulium, Ytterbium, Lutetium, Gadolinium, Magnesium or Manganese, said fluorescent powders contains Ca, Sr, Ba, Mg, Cl, SiO₄, Dy, the original powders contain metal chemical combination oxidation, nitrate, organic metal combination or their metal salts (Na2SO4, CaSO4, BaSO4).

7. The white LED recited in claim 1, wherein said red fluorescent powder applies Na₂S process, with addition of Sm for better luminant efficiency and heat-resistance, said red fluorescent powders contains Ca, Sr, Ba, S, Cl, Eu, Sm, the original powders contain metal chemical combination oxidation, nitrate, organic metal combination or their metal salts (Na2SO4, CaSO4, BaSO4).

8. The white LED recited in claim 1, wherein aid blue fluorescent powder (Ca_{1-x-y},Srₓ,Ba_{y})₅(PO₄)₃Cl:Eu²⁺ with addition of Gd in production for better luminant efficiency, said blue fluorescent powders (Ca_{1-x-y},Srₓ,Ba_{y})₅(PO₄)₃Cl:Eu²⁺Gd²⁺ contains Ca, Sr, Ba, PO₄, Cl, Eu, Gd chemical elements, the original powders contain metal chemical combination oxidation, nitrate, organic metal combination or their metal salts (Na2SO4, CaSO4, BaSO4).

9. The white LED recited in claim 1, wherein said excitation light source includes either one of LED die or LASER LED die.

10. A white LED comprising:
a carrier with a protruding part on a plane or a protruding part on a concave to lift luminant efficiency for better brighter efficiency;
an excitation light source installed on top of said protruding part on a plane or said protruding part on a concave of said carrier, said excitation light source issues light beam with wavelength between 250 nm to 490 nm;
a packaging installed on top of said carrier to cover said excitation light source and fix said excitation light source firmly on said carrier; and
a fluorescent powder installed inside said packaging to receive light beam issued by said excitation light source, said fluorescent powder one or more of (Me_{1-x-y}EuₓRe_{y})₈Mg_{z}(SiO₄)ₘ,Clₙ:,(Me₁₋ₓEuₓ)ReS, Gd²⁺ and (Ca_{1-x-y},Srₓ,Ba_{y})₅(PO₄)₃Cl:Eu²⁺.

11. The white LED recited in claim 10, wherein several wires connect said excitation light source and said carrier electrically.

12. The white LED recited in claim 10, wherein said carrier includes either one of lead frame or circuit board.

13. The white LED recited in claim 10, wherein said excitation light source includes either one of LED die or LASER LED die.

14. The white LED recited in claim 10, wherein the light beam has wavelength between 440 nm to 490 nm, then said fluorescent powder contains one or more of (Me_{1-x-y}EuₓRe_{y})₈Mg_{z}(SiO₄)ₘ,Clₙ:, and (Me₁₋ₓEuₓ)ReS.

15. The white LED recited in claim 10, wherein the light beam has wavelength between 250 nm to 440 nm, then said fluorescent powder contains one or more of (Me_{1-x-y}EuₓRe_{y})₈Mg_{z}(SiO₄)ₘ,Clₙ:, (Me₁₋ₓEuₓ)ReS, Gd²⁺, and Ca_{1-x-y},Srₓ,Ba_{y})₅(PO₄)₃Cl:Eu²⁺.

16. The white LED recited in claim 10, wherein 0<x≦0.8, and 0≦y≦2.0, 0≦Z≦1.0, 1.0≦m≦6.0, 0.1≦n≦3.0, the original powders contain metal chemical combination oxidation, nitrate, organic metal combination or their metal salts (Na2SO4, CaSO4, BaSO4).

17. The white LED recited in claim 10, wherein Me contains more than one more member of Calcium, Strontium and Barium groups.

18. The white LED recited in claim 10, wherein Re contains more than one member of Praseodymium, Rubidium, Samarium, Dysprosium, Holmium, Yttrium, Erbium, Europium, Thulium, Ytterbium, Lutetium, Gadolinium, Magnesium and Manganese groups.

19. A white LED die and green LED die comprising:
a white LED die issuing a light beam with wavelength between 250 nm to 490 nm, said LED dies and a fluorescent powder further comprise:
a circuit board;
an LED die;
an electrical conductive buffer layer located between said circuit board and said LED die;
a positive electrode connecting to and above said electrical conductive buffer layer;
a negative electrode connecting to said electrical conductive buffer layer is isolated to the first and second bond courses, luminant layer, contacting layer and said positive and negative electrodes; and
a fluorescent powder layer surrounding said LED dies to receive light beam by the excitation light sources, said fluorescent powders contains more than one of (Me_{1-x-y}EuₓRe_{y})₈Mg_{z}(SiO₄)ₘ,Clₙ:, (Me₁₋ₓEuₓ)ReS, and (Ca_{1-x-y},Srₓ,Ba_{y})₅(PO₄)₃Cl:Eu²⁺, Gd²⁺.

20. The white LED die and green LED die recited in claim 19, wherein said white LED die's wavelength between 440 nm to 490 m, said fluorescent powder contains more than one of (Me_{1-x-y}EuₓRe_{y})₈Mg_{z}(SiO₄)ₘ,Clₙ: and (Me₁₋ₓEuₓ)ReS.

21. The white LED die and green LED die recited in claim 19, wherein said green LED die's wavelength between 250 nm to 440 nm, said fluorescent powder contains more than one of (Me_{1-x-y}EuₓRe_{y})₈Mg_{z}(SiO₄)ₘ,Clₙ:, (Me₁₋ₓEuₓ)ReS, (Ca_{1-x-y},Srₓ,Ba_{y})₅(PO₄)₃Cl:Eu²⁺ and Gd²⁺.

22. The white LED die and green LED die recited in claim 19, wherein 0<x≦0.8, and 0≦y≦2.0, 0≦Z≦1.0, 1.0≦m≦6.0, 0.1≦n≦3.0.

23. The white LED die and green LED die recited in claim 19, wherein Me contains more than one more member of Calcium, Strontium and Barium groups.

24. The white LED die and green LED die recited in claim 19, wherein Re contains more than one member of Praseodymium, Rubidium, Samarium, Dysprosium, Holmium, Yttrium, Erbium, Europium, Thulium, Ytterbium, Lutetium, Gadolinium, Magnesium and Manganese groups.

25. The white LED die and green LED die recited in claim 19, wherein a plane or a protruding part on a concave on said circuit board to carry said LED dies.

26. The white LED die and green LED die recited in claim 19, wherein the thickness of said fluorescent powder layer is between 0.5 mm to 3.0 mm.

27. The white LED die and green LED die recited in claim 19, wherein the material of said circuit board contains at least Sapphire, SiC, ZnO, Si, GaP and GaAs.
